(19) United States
(12) Patent Application Publication
(10) Pub. No.: US 2004/0081294 A1
(43) Pub. Date: Apr. 29, 2004

(54) Data transfer notification

(76) Inventors: Charles Edward Schinner, Windsor, CO (US); Miles Kevin Thorland, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/280,929

(22) Filed: Oct. 25, 2002

(51) Int. Cl. H04M 1/64; H04M 11/00

(52) U.S. Cl. 379/88.12; 379/100.06

(57) ABSTRACT

Disclosed are systems and methods for providing data transfer notification. In one embodiment, a method for notifying a recipient user includes detecting pickup of a receiver of a telephone connected to a telephone line to which the data receiving device is connected, interrupting data transmission to the data receiving device, notifying the recipient of the data transfer with a spoken message using the telephone receiver. In one embodiment, a system for notifying a recipient user includes logic configured to detect pickup of a telephone receiver of a telephone connected to a telephone line to which a data receiving device is connected, logic configured to facilitate interruption of data transmission from a data sending device to the data receiving device, and logic configured to facilitate presentation of a spoken message using the telephone receiver that explains that a data transfer is being attempted.

### FIELD OF THE DISCLOSURE

The present disclosure relates to data transfer notification. More particularly, the disclosure relates to systems and methods for notifying a user that he or she is receiving a data transfer over a telephone line.

### BACKGROUND

Data is often transferred using telephone systems such as plain old telephone systems (POTS) and wireless telephone systems. For example, many facsimile machines are designed to transfer fax data to a recipient facsimile machine or an appropriate facsimile application that executes on a computing device, such as a personal computer (PC). To cite another example, image data can be transferred over telephone system lines from a server computer to an appropriate viewing device such as the Cieva™ digital picture frame. Other devices adapted for receiving and/or transmitting data are currently being developed.

Such data transfers involve the transmission of various audible tones over the telephone system lines according to predetermined protocols. When a transmission is initiated, the recipient's line rings, the data receiving device is initiated, and various handshaking occurs between the data receiving device and the data sending device in the form of audible tones transmitted back and forth.

In that the recipient's phone rings when a data transfer is initiated, the recipient may pick up his or her telephone receiver due to the mistaken belief that the ringing identifies an incoming voice phone call. When this occurs, the recipient is bombarded by high-pitched screeching noises of the data sending device and/or the data receiving device. This noise can be annoying to the recipient and, where the recipient is not technically savvy, can confuse the recipient as to the purpose for-the noise. In the latter case, the recipient may stay on the line in an attempt to answer an incoming call, thereby interrupting the data transmission. Moreover, where the data sending device attempts to send the data a second time, the recipient may again attempt to answer the call, again fouling the transmission of the data.

From the above, it can be appreciated that it would be desirable to provide a recipient user with a notification that a data sending device is attempting to transmit data to a data receiving device of the recipient user.

### SUMMARY

Disclosed are systems and methods for providing data transfer notification. In one embodiment, a method for notifying a recipient user includes detecting pickup of a receiver of a telephone connected to a telephone line to which the data receiving device is connected, interrupting data transmission to the data receiving device, notifying the recipient of the data transfer with a spoken message using the telephone receiver.

In one embodiment, a system for notifying a recipient user includes logic configured to detect pickup of a telephone receiver of a telephone connected to a telephone line to which a data receiving device is connected, logic configured to facilitate interruption of data transmission from a data sending device to the data receiving device, and logic configured to facilitate presentation of a spoken message using the telephone receiver that explains that a data transfer is being attempted.

### BRIEF DESCRIPTION OF THE DRAWINGS

The nature of the disclosed data transfer notification can be better understood with reference to the following drawings. The components in these drawings are not necessarily to scale.

FIG. 1 is a schematic view of an embodiment of a system with which data transfer notification can be provided.

FIG. 2 is a block diagram of an example embodiment of a data sending device shown in FIG. 1.

FIG. 3 is a block diagram of an example embodiment of a data receiving device shown in FIG. 1.

FIG. 4 is a flow diagram that illustrates an embodiment of operation of the system of FIG. 1 in facilitating data transfer notification.

FIG. 5 is a flow diagram that illustrates an embodiment of operation of a remote data transfer notification utility of the data sending device of FIG. 2.

FIG. 6 is a flow diagram that illustrates an embodiment of operation of a local data transfer notification utility of the data receiving device of FIG. 3.

FIG. 7 is a flow diagram that illustrates another embodiment of operation of the system of FIG. 1 in facilitating data transfer notification.

### DETAILED DESCRIPTION

Disclosed herein are systems and methods through which recipients can be notified that they are or will be receiving a data transmission over a telephone system such as a plain old telephone system (POTS) or a wireless telephone system. With these systems and methods, the recipient user can not only be notified as to the fact that the transmission is occurring or is about to occur, but also can be instructed as to how to proceed to enable the transmission to be completed or, where applicable, override it.

Example systems for providing data transfer notification are first discussed with reference to the figures. Although these systems are described in detail, it will be appreciated that these systems are provided for purposes of illustration only and that various modifications are feasible. After the example systems have been described, examples of operation of the systems are provided to explain the manners in which data transfer notification can be facilitated.

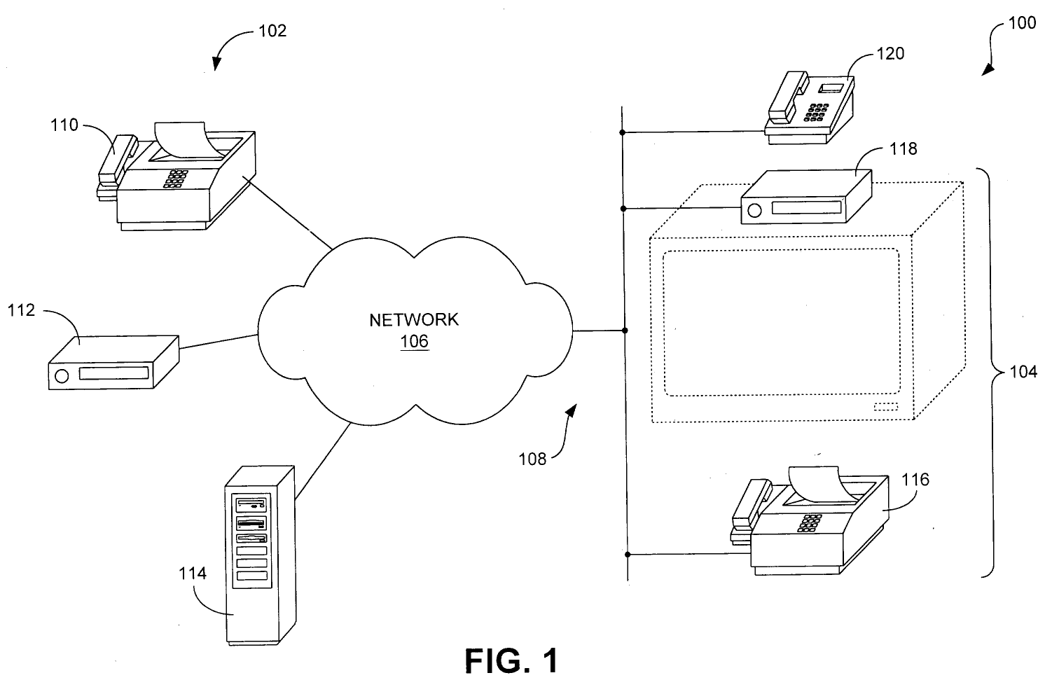

Referring now in more detail to FIG. 1, illustrated is an example system 100 with which data transfers can be achieved and with which data transfer notification can be provided. As indicated in this figure, the system 100 generally comprises one or more data sending devices 102 and one or more data receiving devices 104. Each of the data sending devices 102 is configured to transmit data to one or more of the data receiving devices 104 over a network 106 that is in communication with the recipient's home or office telephone line 108 (either a POTS or wireless “line”).

By way of example, the data sending devices 102 comprise a facsimile machine 110 that is capable of transmitting scanned data, a data transceiver 112 that is capable of transmitting stored image and/or text data, and a computing device 114 (e.g., personal computer (PC) or server computer) that, through the provision of an appropriate software application and transmission hardware, is capable of transmitting various different types of viewable or printable data. Although these particular data sending devices 102 are shown in FIG. 1 and have been explicitly identified herein, it is to be understood that a data sending device can comprise substantially any device that is capable of transmitting data to a data receiving device 104 via a telephone line.

The data receiving devices 104 comprise substantially any device that is capable of receiving data transmitted from a data sending device 102. For instance, as indicated in FIG. 1, the data receiving devices 104 can comprise a recipient facsimile machine 116 and/or a recipient data transceiver 118 that, as depicted, can be used in conjunction with an appropriate display device such as a television set. Although particular data receiving devices 104 are shown and have been described, persons having ordinary skill in the art will appreciate that alternative data receiving devices are possible. For instance, a data receiving device could comprise the recipient's PC or other computing device where that PC or other computing device comprises software and/or firmware that is configured to receive and display data transmitted from a data sending device 102.

The network 106 typically comprises one or more sub-networks that are communicatively coupled to each other. These networks can include one or more telephone system networks, local area networks (LANs), and/or wide area networks (WANs). In some embodiments, the network 106 may comprise a set of networks that forms part of the Internet. Also shown connected to the recipient's telephone line 108 is a telephone 120 that the recipient may use to make and receive phone calls and, as described below, may be used to provide data transfer notifications and/or instructions to the recipient.

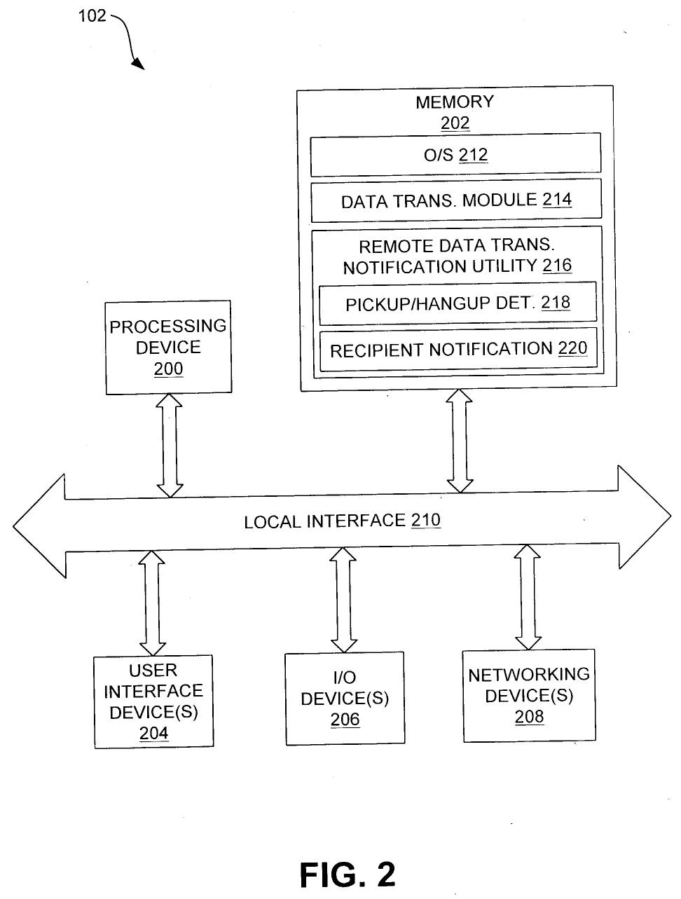

FIG. 2 is a block diagram illustrating an example architecture for the data sending devices 102 shown in FIG. 1. As indicated in FIG. 2, each data sending device 102 can comprise a processing device 200, memory 202, one or more user interface devices 204, one or more I/O devices 206, and one or more networking devices 208, each of which is connected to a local interface 210. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the data sending device 102.

The one or more user interface devices 204 comprise those components with which the sender user can interact with the data sending device 102. Where the data sending device 102 comprises a facsimile machine or other such device, the user interface devices 204 may comprise one or more keys or buttons and a basic display (e.g., liquid crystal display (LCD)). Where the data sending device 102 comprises a computing device such as a PC or server computer, these components can comprise those typically used in conjunction with a PC, such as a keyboard and mouse.

The one or more I/O devices 206, where provided, comprise components used to facilitate connection of the data sending device 102 to other devices. These devices can, for instance, comprise one or more serial, parallel, small computer system interface (SCSI), universal serial bus (USB), IEEE 1394 (e.g., Firewire™), or personal area network (PAN) connection devices. The networking devices 208 comprise the various components used to transmit (and/or receive) data over the network 106. By way of example, the networking devices 210 include a device that can communicate both inputs and outputs, for instance, a modulator/demodulator (e.g., modem), network card, etc.

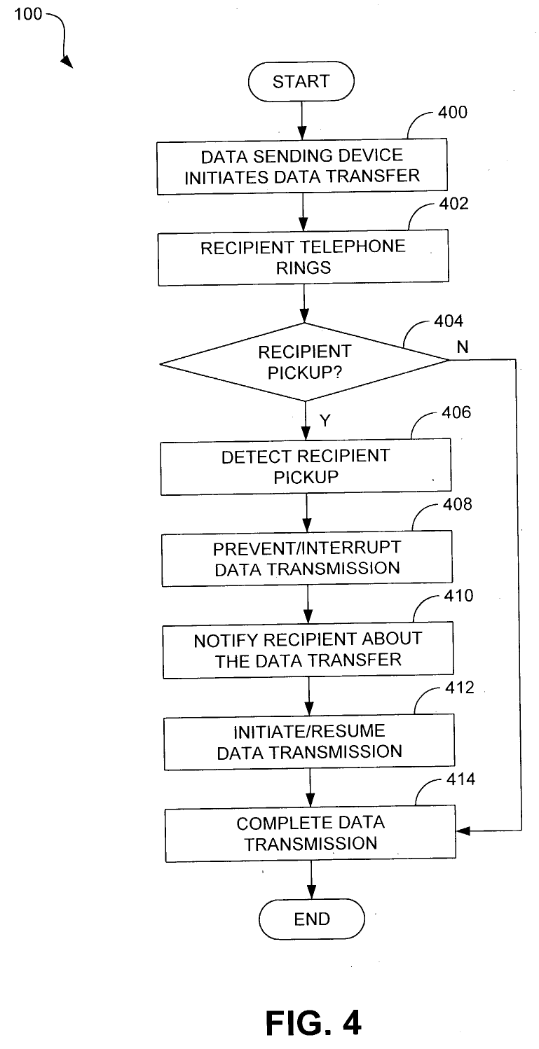

The memory 202 normally comprises various programs (software and/or firmware) including an operating system (O/S) 212 that controls the execution of other software/firmware and provides scheduling, input-output control, file and data management, memory management, and communication control and related services. In addition, the memory 202 comprises a data transmission module 214 that is used to package data and otherwise facilitate its transmission to a data receiving device 104. Optionally, the memory 202 can further comprise a remote data transmission notification utility 216 that includes a remote pickup/hangup detection module 218 and a remote recipient notification module 220. As is discussed in greater detail below with reference to FIGS. 4-6, the remote pickup/hangup detection module 218 is used to detect the pickup and/or hangup of a telephone receiver by the recipient and the remote recipient notification module 220 is used to notify the recipient of a data transmission that the data sending device 102 is attempting to complete.

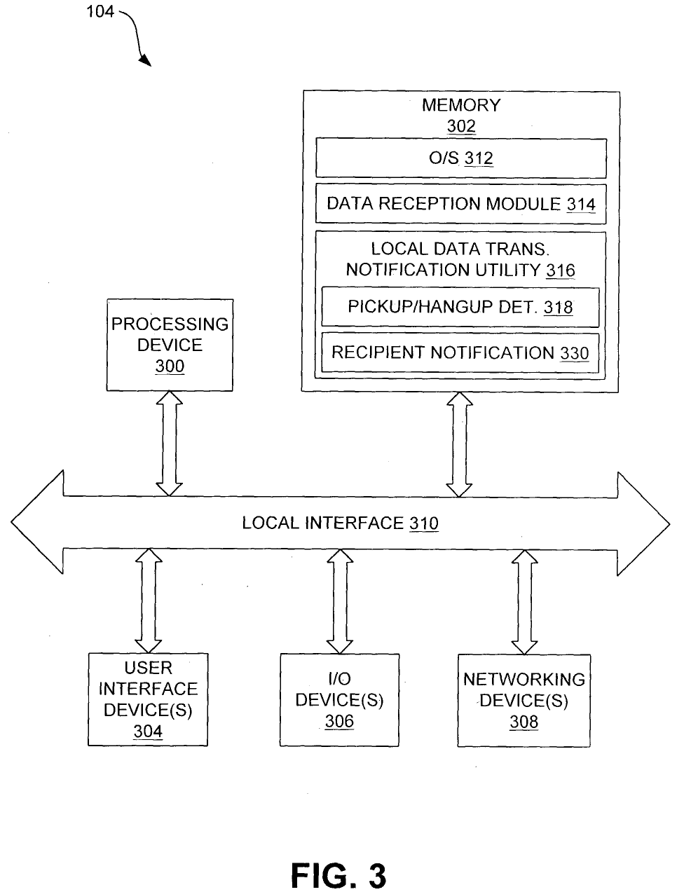

FIG. 3 is a block diagram illustrating an example architecture for the data receiving devices 104 shown in FIG. 1. As indicated in FIG. 3, each data receiving device 104 can have a configuration similar to that of the data sending devices 102. This may particularly be the case where the data receiving device 104 is the same type of device as the data sending device 102. Accordingly, each data receiving device 104 can comprise a processing device 300, memory 302, one or more user interface devices 304, one or more I/O devices 306, and one or more networking devices 308. Each of these components is connected to a local interface 310 that, by way of example, comprises one or more internal buses.

The memory 302, like memory 202, also includes an operating system 312 that contains the various commands used to control the general operation of the data receiving device 104. In addition, however, the memory 302 comprises a data reception module 314 that is used to unpack data received from data sending devices 102 for viewing, and can further comprise a local data transmission notification utility 316 that includes a local pickup/hangup detection module 318 and a local recipient notification module 320 that serve similar functions as the remote pickup/hangup detection module 218 and recipient notification module 220 identified above. Examples of operation of the local pickup/hangup detection module 318 and the local recipient notification module 320 are described with reference to FIGS. 4-6 below.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussion that follows, flow diagrams are provided. It is to be understood that any process steps or blocks in these flow diagrams may represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

As noted above, the system 100 can be used to notify a recipient user that a sending device is sending or about to send data to the recipient's data receiving device 104. A high-level example of the system 100 operating in such a capacity is illustrated in FIG. 4. Beginning with block 400 of this figure, the data sending device 102, presumably upon the initiation of the sender user, initiates a data transfer to the recipient data receiving device 104. By way of example, this initiation occurs under the control of with the data transmission module 214. As identified above, the data that is to be transferred can comprise substantially any data that can be viewed and/or printed (depending upon the nature of the data receiving device) and, therefore, may comprise images, text, and the like. Through this initiation, the recipient's telephone rings, as indicated in block 402. As described in the foregoing, this ringing may motivate the recipient to pick up the receiver of a telephone (e.g., telephone 120 in FIG. 1) that is connected to the recipient's telephone line 108.

With reference to decision block 404, if the recipient does not pick up the receiver, data transfer can take place uninterrupted and flow continues down to block 414 described below. If, on the other hand, the recipient does pick up, flow continues to block 406 at which the pickup is detected. The nature of this detection may depend upon the specific configuration of the system and/or the mode of operation that has been selected by the sender and/or recipient. In one embodiment, pickup is detected by the data sending device 102 and, more particularly, by the remote pickup/hangup detection module 218. In another embodiment, pickup is detected by the local pickup/hangup detection module 318 of the data receiving device 104. Examples of each scenario are described below.

Next, with reference to block 408, the data transmission is prevented if it has not yet begun or, if it has, is interrupted. Like the detection described above, the manner in which this prevention/interruption is achieved may depend upon the configuration of the system or the mode in which it is operating. Where the pickup was detected by the data sending device 102, the remote pickup/hangup detection module 218 may signal the data transmission module 214 to halt transmission. Where the pickup was detected by the data receiving device 104, the local pickup/hangup detection module 318 may transmit a signal to the data sending device 102 to interrupt transmission.

In any case, once transmission has been prevented or interrupted, no further audible tones (i.e., screeching noises) will be heard by the recipient who picked up the telephone receiver. At this point, the recipient can be notified about the data transfer, as indicated in block 410. The nature of this notification can vary depending upon the desired implementation. However, the notification typically comprises a spoken (e.g, recorded or computer generated) voice message that identifies that a data transfer was occurring or is about to occur, and that the recipient should hang up if he or she wishes to receive the transfer. For instance, the notification may state “You are receiving a data transfer. Please hang up the telephone so that the transfer may be completed. Thank you.” Where the communication link between the data sending device 102 and the data receiving device 104 has been broken, the notification may further provide an indication that, upon hangup, the data transfer will be attempted again. In such a scenario, the notification may further state, for example, “After you hang up the telephone, it will ring again when the data transfer resumes. Please do not pick up the telephone receiver so that the transfer may be completed.” Furthermore, the notification can include a general indication of how long the transmission will take. For example, the notification could further state “If you wish to receive this transmission in its entirety, please do not pick up the telephone receiver for approximately 10 minutes. Thank you.” Persons having ordinary skill in the art will appreciate that other such information can be provided to the recipient. For instance, as is described below, the recipient can, optionally, be provided with instructions as to how to override the data transmission in situations in which he or she would like to use the telephone or keep the line open.

Once the recipient hangs up, the data transmission can be initiated or resumed as the case may be, as indicated in block 412. This initiation/resumption typically occurs upon receipt by the data transmission module 214 of a resumption signal provided by one of the remote and local data transfer notification utility 216 and 316. As identified above, initiation or resumption may require a new call to the recipient data receiving device 104 in situations in which the communication link between the data sending device 102 and the data receiving device was broken. Next, with reference to block 414, the data transmission can be completed.

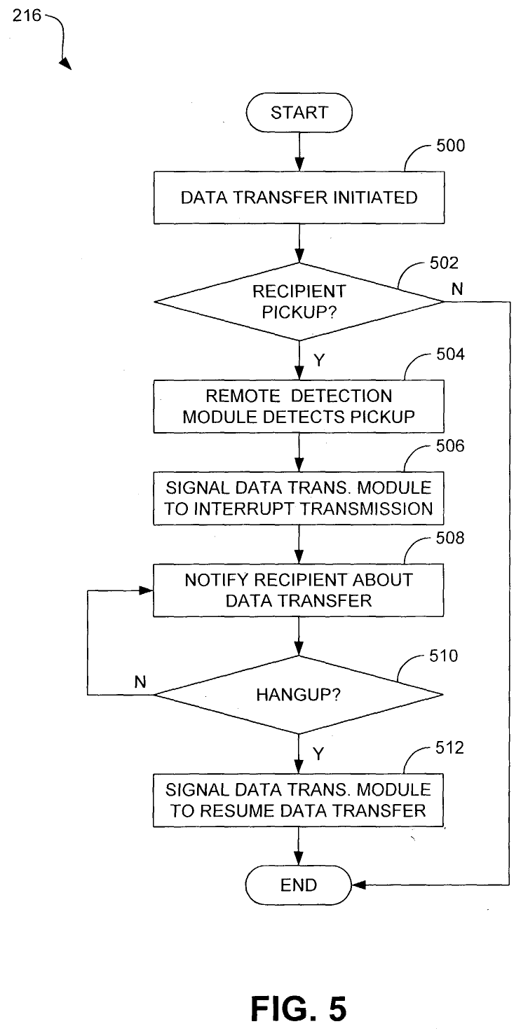

FIG. 5 provides an example of operation of the remote data transfer notification utility 216. More specifically, FIG. 5 illustrates operation of the remote data transfer notification utility 216 in a scenario in which detection of recipient pickup and recipient notification is controlled from the sender side of the system. Beginning with block 500 of this figure, a data transfer is initiated by the data sending device 102 in the manner described above with reference to FIG. 4. As a result of the transfer initiation, the recipient's telephone rings and, as indicated in block 502, it can be determined whether the recipient has picked up the telephone receiver. If no such pickup occurs, no recipient notification is necessary and flow is terminated (data transfer continues). However, if the recipient does pick up, the pickup is detected using the remote pickup/hangup detection module 218, as indicated in block 504. The manner in which the module 218 detects the pickup depends upon its configuration. By way of example, pickup can be determined by detecting the sound that is made when the receiver is lifted from its cradle or is otherwise activated (one or a series of audible clicks), in combination with detecting a human voice expressing a greeting (e.g., “Hello”). This form of detection can be conducted using one or more appropriate algorithms comprised within the pickup/hangup detection module 218.

Once the pickup has been detected, the remote pickup/hangup detection module 218 signals the data transmission module 214 to interrupt the data transmission, as indicated in block 506. At this point, the recipient notification module 220, as indicated in block 508, notifies the recipient about the data transfer using spoken words, as described above in relation to FIG. 4. Through this notification, the recipient can be provided with information about the data transfer and instructions as to how to enable it (e.g., hang up the telephone, avoid picking up the receiver, etc.). In that the data sending device 102 is providing the notification, the notification may further include specific information about the data and who is providing it. For instance, the notification could state “Ten images are being transferred to you from Joe Smith.”

Next, with reference to decision block 510, it can be determined whether the recipient has hung up using the pickup/hangup detection module 318. This determination can be made in similar manner to the pickup detection. Accordingly, the module 318 can “listen” for the noises associated with hangup (e.g., one or a series of audible clicks). Alternatively or in addition, the module 318 can listen for the cessation of further words spoken by the recipient over a given period of time (e.g., 10 seconds). Irrespective of the manner in which the determination is made, however, the pickup/hangup detection module 318 can then signal the data transmission module 214 to resume data transfer (i.e., continue or reinitiate the data transmission), as indicated in block 512. If the recipient does not hang up, however, flow may return to the block 508 at which the same, or different, notification is provided to the recipient.

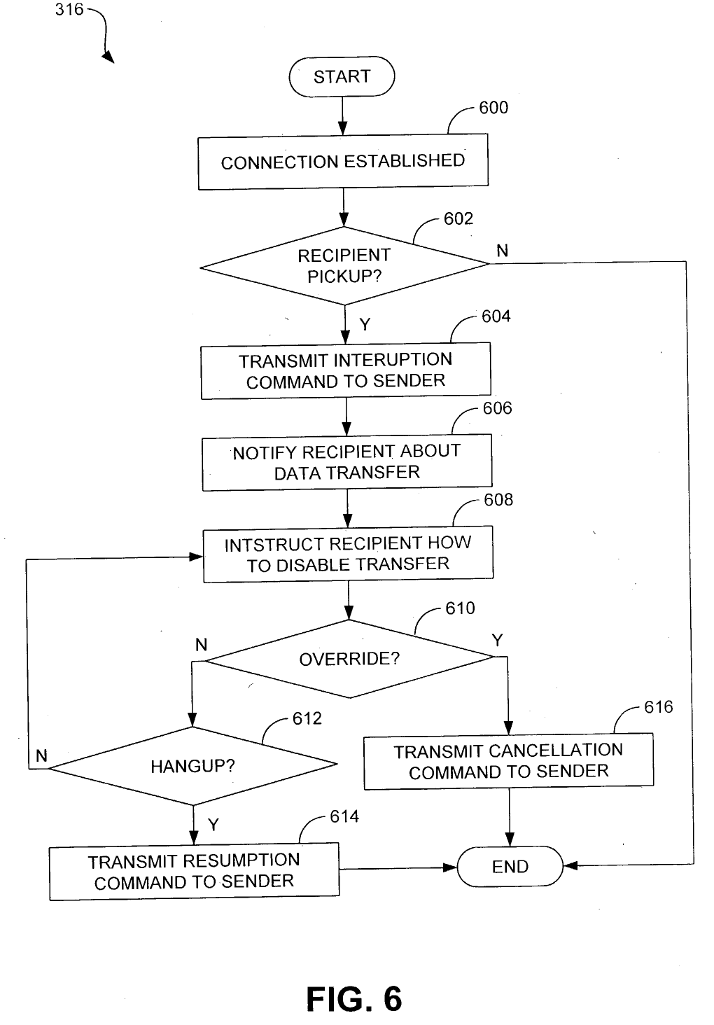

FIG. 6 provides an example of operation of the local data transfer notification utility 316. More specifically, FIG. 6 illustrates operation of the local data transfer notification utility 316 in a scenario in which detection of recipient pickup and recipient notification is controlled from the recipient side of the system. Beginning with block 600 of FIG. 6, a connection is established between the data sending device 102 and the data receiving device 104. The established nature of the connection means that the data sending device 102 and data receiving device 104 have carried out the necessary handshaking required by the transmission protocol to establish a communication link and data transfer has begun. Accordingly, the recipient has presumably not interrupted the transfer process up to this stage, or the data transfer has been resumed in the manner described above with reference to FIG. 5.

At this point, it can be determined whether the recipient then picks up the receiver of his or her telephone, for instance during the middle of the data transmission, as indicated in decision block 602. In this case, the determination is made by the local pickup/hangup detection module 318. Where the telephone line 108 comprises a POTS line, the detection can be made, for example, by detecting a power drop (voltage and/or current) that occurs on the telephone line during an off-hook condition using an appropriate algorithm in conjunction with an analog circuit (not identified) that resides in the data receiving device 104 and which measures the ringer equivalents on the telephone line.

If no pickup is detected, no notification is necessary and flow is terminated. If the recipient does pickup, however, flow continues to block 604 at which an interrupt command is transmitted, for example over the network 106, to the data sending device 102. Once the data transmission is interrupted, the recipient can be notified as to the data transfer in the manner described above, as indicated in block 606. Notably, in that a connection has been established and the data transfer begun, the notification may include information as to the type of data being transferred and the person who sent it, assuming this information was included in the transfer (e.g., in one or more headers), as well as other pertinent information such as the estimated duration of the data transfer. In addition to this form of notification, the recipient can be provided with instructions as to how to disable, cancel, or defer the data transfer, as indicated in block 608. These instructions may be useful to the recipient in a situation in which the recipient user desires to place a call (e.g., during an emergency) or is expecting an imminent call. By way of example, such disabling can be effected by the recipient by pressing a particular, or any, key on the telephone key pad. In another arrangement, the disable function can be automatically inferred by the selection of a particular code, such as “9-1-1,” which indicates an urgent need to use the telephone.

Next, flow continues to decision block 610 at which it is determined if the recipient does desire to disable the transfer. If not, it can be determined whether the recipient has hung up the telephone receiver, as indicated in decision block 612, using the pickup/hangup module 318 in the manner discussed above. If not, flow can return the block 608 and the recipient again notified as to the data transfer. If so, flow may continue to block 614 and a transmit resumption command is transmitted to the data sending device 102.

With reference back to decision block 610, if the recipient does wish to disable the data transfer for some predetermined amount of time (e.g., thirty minutes), flow may continue to block 616 at which a cancellation command is transmitted back to the data sending device 102.

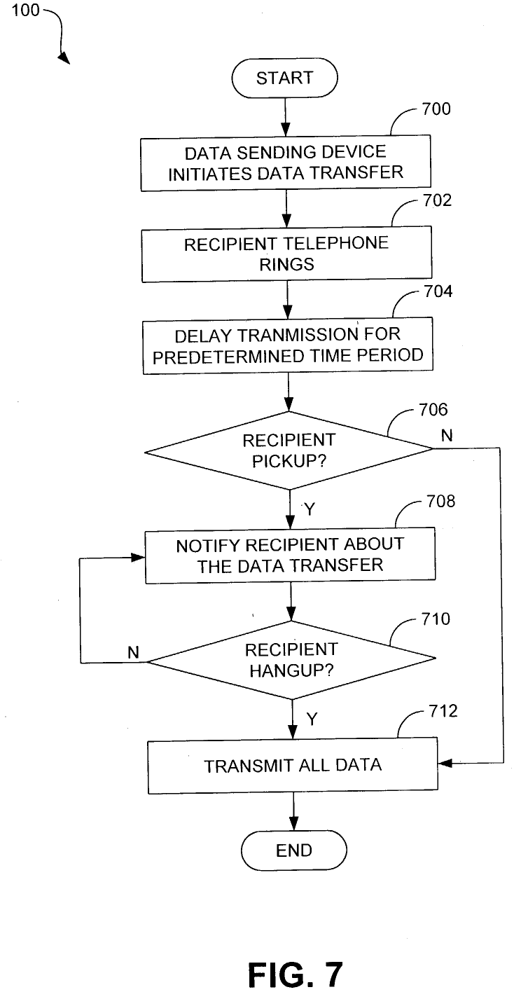

FIG. 7 provides another example of the system 1 00 in providing notification to a recipient user. Beginning with block 700 of this figure, the data sending device 102 initiates a data transfer to the recipient data receiving device 104, such that the recipient's telephone rings and the data receiving device answers, as indicated in block 702. As indicated in block 704, the transmission of data is delayed for a predetermined period of time (e.g., 10 seconds) so that if the recipient does pick up the receiver, the transmission will not need to be interrupted mid-stream.

With reference next to decision block 706, it can be determined whether the recipient did pick up the telephone receiver. If not, data transfer can take place uninterrupted and flow continues down to block 712 below. If, however, the recipient does pick up, flow continues to block 708 and the recipient is notified about the data transfer in any of the manners described above.

Assuming the recipient does hang up (decision block 710), flow proceeds to block 712 and all data are transmitted. If no such hangup is detected, however, flow may return to block 708 after a predetermined delay and further notifications and/or instructions may be provided to the recipient. If after an number of re-notifications (e.g., replaying of the message), the data sender device will abort/cancel the transmission. With the unsuccessful attempt, the data sender will try again at a later time.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for notifying a recipient user of a data transfer to a data receiving device, comprising:
detecting pickup of a receiver of a telephone connected to a telephone line to which the data receiving device is connected;
interrupting data transmission to the data receiving device;
notifying the recipient of the data transfer with a spoken message using the telephone receiver.

2. The method of claim 1, wherein the step of detecting pickup comprises detecting pickup using a remote detection module of a data sending device that is attempting to transfer data to the data receiving device.

3. The method of claim 2, wherein the step of detecting pickup further comprises detecting the recipient user's voice in answering the telephone.

4. The method of claim 2, wherein the step of interrupting data transmission comprises signaling a data transmission module of the data sending device to halt transmission.

5. The method of claim 1, wherein the step of detecting pickup comprises detecting pickup using a local detection module of the data receiving device.

6. The method of claim 5, wherein the step of detecting pickup further comprises detecting a power drop on the telephone line.

7. The method of claim 5, wherein the step of interrupting data transmission comprises transmitting an interrupt command from the data receiving device to a data sending device that is attempting to transfer data to the data receiving device.

8. The method of claim 1, wherein the step of notifying the recipient user comprises notifying the user as to at least one of the type of data, the sender of the data, and an estimate of the duration of transfer.

9. The method of claim 1, wherein the step of notifying the recipient user comprises providing instructions as to how to enable or disable the data transfer.

10. The method of claim 1, further comprising detecting hangup and resuming data transmission.

11. A system for notifying a recipient user of a data transfer, comprising:
means for detecting pickup and hangup of a telephone receiver;
means for interrupting data transmission to the data receiving device upon detection of receiver pickup;
means for notifying the recipient of the data transfer with a spoken message; and
means for resuming data transfer upon detection of receiver hangup.

12. The system of claim 11, wherein the means for detecting pickup comprise means for detecting a recipient user's voice.

13. The system of claim 11, wherein the means for detecting pickup and hangup comprise means for detecting a power drop on a telephone line.

14. The system of claim 11, wherein the means for detecting hangup comprise means for detecting noise associated with hangup of a receiver.

15. A system for notifying a user as to a data transfer, comprising:
a telephone system;
a data sending device in communication with the telephone system;
a data receiving device in communication connected to the telephone system and configured to receive data transmitted from the data sending device; and
a data transfer notification utility stored on one of the data sending device and the data receiving device, the data transfer device being configured to detect receiver pickup by the user and, upon such detection, notify the user as to a data transfer that is occurring or is about to occur.

16. The system of claim 15, wherein the data transfer notification utility is further configured to detect hangup by the user and, upon such detection, resume the transfer of data to the data receiving device.

17. A data transfer notification program stored on a computer-readable medium, the program comprising:
logic configured to detect pickup of a telephone receiver of a telephone connected to a telephone line to which a data receiving device is connected;
logic configured to facilitate interruption of data transmission from a data sending device to the data receiving device; and
logic configured to facilitate presentation of a spoken message using the telephone receiver that explains that a data transfer is being attempted.

18. The program of claim 17, wherein the logic configured to detect pickup comprises logic configured to detect a human voice.

19. The program of claim 17, wherein the logic configured to detect pickup comprises logic configured to detect a power drop on a telephone line.

20. The program of claim 17, further comprising logic configured to detect hangup of a telephone receiver.

21. A device, comprising:
a processing device;
memory that stores a data transfer notification utility, the data transfer notification utility including:
logic configured to detect pickup of a telephone receiver of a telephone connected to a telephone line to which the device is connected;
logic configured to facilitate interruption of data transmission from a data sending device; and
logic configured to facilitate presentation of a spoken message to a user that explains that a data transfer is being attempted.

22. The device of claim 21, wherein the logic configured to detect pickup comprises logic configured to detect a human voice.

23. The device of claim 21, wherein the logic configured to detect pickup comprises logic configured to detect a power drop on a telephone line.

24. The device of claim 21, further comprising logic configured to detect hangup of a telephone receiver.

25. The device of claim 21, wherein the device is a data sending device.

26. The device of claim 21, wherein the device is a data receiving device.

27. The device of claim 21, wherein the device is an image transmitting device.
